(19) United States
(12) Patent Application Publication
(10) Pub. No.: US 2025/0349098 A1
(43) Pub. Date: Nov. 13, 2025

(54) DETECT HIDDEN OBJECTS USING VEHICLE AND INFRASTRUCTURE SENSOR FUSION

(71) Applicant: Ford Global Technologies, LLC, Dearborn, MI (US)

(72) Inventors: Keith Weston, Canton, MI (US); John Robert Van Wiemeersch, Novi, MI (US); Brendan Diamond, Naples, FL (US)

(73) Assignee: Ford Global Technologies, LLC, Dearborn, MI (US)

(21) Appl. No.: 18/656,991

(22) Filed: May 7, 2024

(51) Int. Cl. G06V 10/25; G06T 5/50; G06V 20/52

(52) U.S. Cl. CPC G06V 10/25; G06T 5/50; G06V 20/52; G06T 2207/20221; G06V 2201/07

(57) ABSTRACT

A vehicle that can augment data captured by an infrastructure sensor, such as a security camera, is disclosed. The vehicle includes processors, a memory, a communication interface, and one or more sensors coupled. The vehicle may receive a first image of a region of interest. The first image depicts that a first portion of the vehicle is obscuring a first portion of the region of interest. The vehicle may also receive a request to capture an image of the region of interest. The vehicle captures a second image of the first portion of the region of interest and generates, using the first image and the second image, a combined image. In the combined image the first portion of the vehicle in the first image is replaced with the first portion of the region of interest from the second image.

### FIELD

The present disclosure relates to the field of detecting objects that may be blocked from view by a vehicle.

### BACKGROUND

There are instances where a security camera cannot “see” a certain region within its field of view because a vehicle or some other object is blocking the view. If there is any object present in that blocked region, the security camera is not able to detect or identify that object. This may present a security issue as the blocked region cannot be effectively monitored.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a system in which the techniques of the present disclosure may be implemented according to an embodiment of the present disclosure.

FIG. 2 illustrates a block diagram of a vehicle according to an embodiment of the present disclosure.

FIG. 3 illustrates a schematic showing the environment in which the techniques of this disclosure can be implemented according to an embodiment of the present disclosure.

FIG. 4A illustrates a view from an infrastructure sensor according to an embodiment of the present disclosure.

FIG. 4B illustrates a view showing a vehicle blocking a portion of the region of interest according to an embodiment of the present disclosure.

FIG. 4C illustrates a view in which the vehicle blocking the portion of the region of interest is made transparent/invisible according to an embodiment of the present disclosure.

FIG. 5 illustrates a view in which the relative location of a vehicle in a region of interest is depicted according to an embodiment of the present disclosure.

FIG. 6 illustrates a view in which objects around and underneath the vehicle are depicted along with an outline showing the location of the vehicle according to an embodiment of the present disclosure.

FIG. 7 is a flow diagram of a process for sensor fusion according to an embodiment of the present disclosure.

FIG. 8 is a flow diagram of a process for sensor fusion according to another embodiment of the present disclosure.

FIG. 9 is a flow diagram of a process for sensor fusion according to yet another embodiment of the present disclosure.

### DETAILED DESCRIPTION

### Overview

The present disclosure describes a system and method for detecting and identifying objects that may be obscured or not visible due to presence of a vehicle that is obscuring a view of the object. For example, a security camera mounted externally to a house may have its view of the driveway and front yard block by a vehicle positioned in the driveway (i.e., the region of interest). In such a situation, if there is some activity or object in the region of interest, the security camera is unable to detect that activity or object. It is often important that the security camera has access to the region of interest. In such instances, the vehicle's sensors may be used to monitor the region of interest and the data captured by the vehicle can be combined with the data captured by the security camera to provide a more complete visualization of the entire region of interest even if the vehicle is physically blocking a portion or the entire region of interest.

In some instances, a vehicle may receive a request to capture an image of a region of interest from a control server. There may be one or more sensors (e.g., infrastructure sensor) associated with the control server, but they may be unable to see the region of interest as it may be blocked by the vehicle. After the vehicle receives the message, the vehicle may capture a first image of the region of interest using a second sensor of the vehicle, e.g., a camera associated with the vehicle. The vehicle may also receive a second image from the control server. The second image may be captured by the one or more sensors associated with the control server, such as a security camera, and may include at least a portion of the vehicle. The vehicle may then generate a combined image using the first and the second images. In the combined image, the portion of the vehicle may be replaced with a portion of the region of interest from the image taken by the vehicle such that the region of interest is now visible as if the vehicle did not exist. In other words, the vehicle is made transparent and one can now “see through” the vehicle and view the previously blocked portion of the region of interest.

In some instances, a user device associated with a vehicle may be running an application that can be used to interact with the vehicle. The user device may receive a first image of a region of interest. The first image may be displayed in the application. The first image may be captured by a first sensor associated with a first entity. The first entity may be a security system associated with a facility like a home or office. In one instance, the user device and the first entity may be owned and/or controlled by the same user. The user device may then determine that a vehicle is at least partially disposed within the region of interest based on the first image. As seen in the first image, a first portion of the vehicle may be blocking a view of a first portion of the region of interest. In this case, the user device may determine an identity of the vehicle and based on the identity, the user device may determine if the vehicle is authorized to be in the region of interest. If the vehicle is authorized, the user device may send a message to the vehicle causing the vehicle to activate one or more sensors of the vehicle. The user device may then receive a second image of the first portion of the region of interest from the vehicle. The user device may then generate a combined image in which at least a portion of the second image is overlaid onto, stitched to, or otherwise combined with the first image such that the full region of interest is visible and the first portion of the vehicle is not visible.

In yet another instance, a vehicle is equipped with sensors, processors, and communication interface. The vehicle may receive a first image of a region of interest from a remote server. In the first image, a first portion of the vehicle may be obscuring/blocking a view of a first portion of the region of interest. The vehicle may also receive a request or otherwise determine to capture an image of the region of interest. Based on that request, the vehicle may capture, using the one or more sensors, a second image of the first portion of the region of interest. Thereafter, the vehicle may generate, using the first image and the second image, a combined image. In the combined image, the first portion of the vehicle in the first image is replaced with the first portion of the region of interest from the second image.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

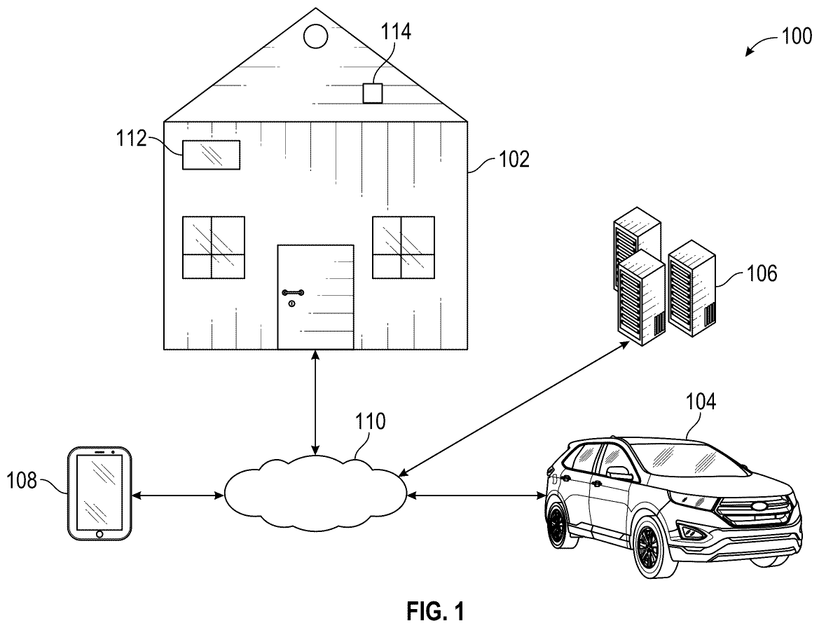

FIG. 1 illustrates a system 100 according to an embodiment of the present disclosure. System 100 may include a facility 102 such as a dwelling, an office building, a retail establishment, or any other structure. Facility 102 may have one or more sensors coupled to it. For example, sensor 112 may be a video camera that is capable of recording video and well as capturing images. Sensor 114 may be a presence detection sensor such as passive infrared sensor, proximity sensor, photoelectric sensor, fiber optic sensor, ultrasonic sensor, RADAR, LiDAR, acoustic sensor, vibration sensor, or the like. Sensors 112 and 114 may be Internet of Things (IoT) sensors that are networked and connected to the network 110 either via wires or wirelessly, or a combination of both. One skilled in the art will realize that any other sensor suitable for the purposes explained below can be used.

System 100 also includes a vehicle 104, a user device 108, and one or more control servers 106 communicatively coupled to each other via one or more networks 110. The user device 108 may be associated with the vehicle user of the vehicle 104, and may be, for example, a mobile phone, a laptop, a computer, a tablet, a smartwatch, a wearable device, or any other device with communication capabilities.

The server 106 may be part of a cloud-based computing infrastructure and may be associated with and/or include a Telematics Service Delivery Network (SDN) that provides digital data services to the vehicle 104. In further aspects, the server 106 may be an “authorities server”, and may be associated with the authorities such as the police or law enforcement personnel. In additional aspects, the server 106 may be an assistance server, and may be associated with at least one of a tow assistance firm, a vehicle maintenance and repair firm, an insurance firm, and a transportation firm. Further, the server 106 may be associated with a security system to which sensors 112 and 114 are connected. Yet further, the server 106 may be co-located with the facility 102 or remote.

The network 110 illustrates an example communication infrastructure in which the connected devices discussed in various embodiments of this disclosure may communicate. The network 110 may be and/or include the Internet, a private network, public network or other configuration that operates using any one or more known communication protocols such as, for example, transmission control protocol/Internet protocol (TCP/IP), Bluetooth®, Bluetooth® low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

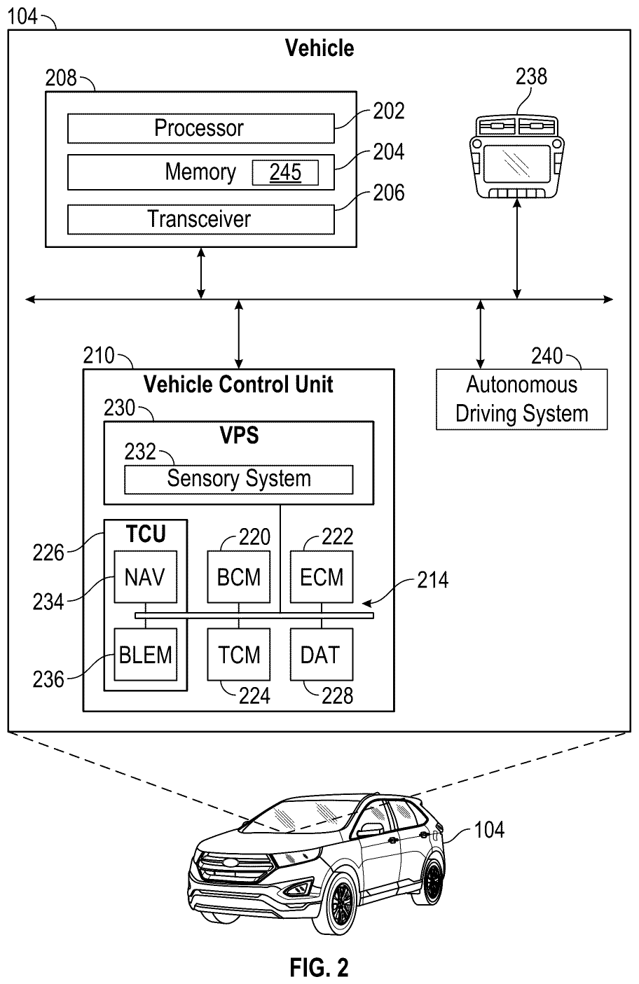

The vehicle 104 may include a plurality of units including, but not limited to, an automotive computer, a Vehicle Control Unit (VCU), and a detection unit. Details of the vehicle are provided below in reference to FIG. 2.

FIG. 2 illustrates a block diagram of a vehicle, e.g., vehicle 104 of FIG. 1. The vehicle 104 may include a plurality of units including, but not limited to, an automotive computer 208, a Vehicle Control Unit (VCU) 210, and an infotainment unit 238. The VCU 210 may include a plurality of Electronic Control Units (ECUs) 214 disposed in communication with the automotive computer 208.

In some embodiments, the user device 108 may be configured to connect with the automotive computer 208 via the network 110, which may communicate via one or more wireless connection(s), and/or may connect with the vehicle 106 directly by using near field communication (NFC) protocols, Bluetooth® protocols, Wi-Fi, Ultra-Wide Band (UWB), and other possible data connection and sharing techniques.

The automotive computer 208 may be installed anywhere in the vehicle 104, in accordance with the disclosure. The automotive computer 208 may be or include an electronic vehicle controller, having one or more processor(s) 202, one more memories 204, and one or more transceivers 206.

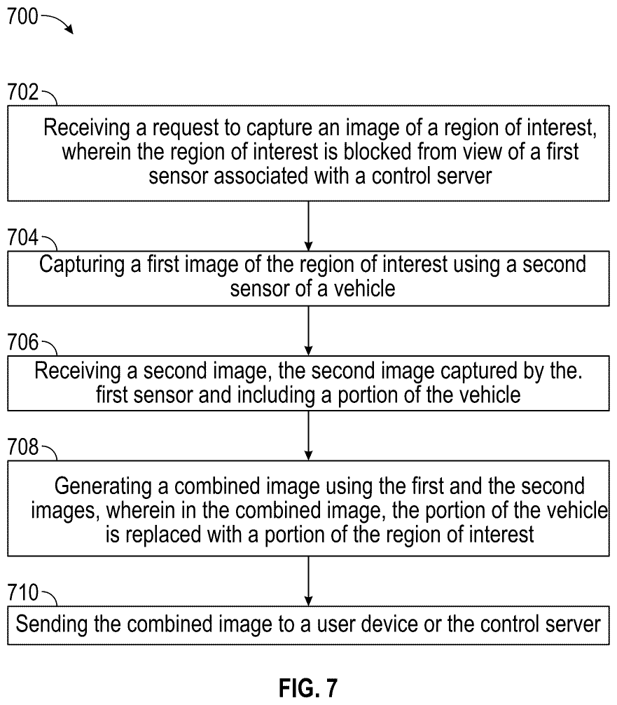

The processor(s) 202 may be disposed in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure, including those processes presented FIGS. 7, 8 and 9. Alternatively, these functions can be distributed among multiple devices, wherein each implements all or a portion of the processes described herein.

Automotive computer 208 may also include a transceiver 206. The transceiver 206 may be configured to receive information/inputs from one or more external devices or systems, e.g., the user device 108, the server 106, the infrastructure sensors 114 and/or 112, and/or the like, via the network 110. Further, the transceiver 206 may transmit notifications, requests, signals, etc. to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power bus with the automotive computer 208 and may be configured and/or programmed to coordinate the data between vehicle systems, connected servers (e.g., the server 106), the infrastructure sensors 114 and 112, and/or the like. The VCU 210 may include or communicate with any combination of the ECUs 214, such as, for example, a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 104 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 104 at one or more locations and in one or more manner. For example, the various sensors of the vehicle sensory system 232 may be integrated into the various subsystems of the vehicle 104, such as doors, bumpers, fenders, mirrors, roof, etc. or attached to the vehicle 104 using an appropriate mounting mechanism. In some embodiments, the various sensors of the vehicle sensory system 232 may be located at the front, back, sides, top, bottom, and underneath the vehicle 104. The location of a sensor may depend on its function. For example, a sensor that monitors the area underneath the vehicle may be connected to a bottom surface of the vehicle 104 while a sensor that can monitor an area to either side of the vehicle 104 may be mounted or integrated into the doors of the vehicle 104. One skilled in the art will realize that the sensors may be coupled to the vehicles in various different ways and locations other than the ones mentioned above.

In some embodiments, the VCU 210 may control vehicle operational aspects and implement one or more instruction sets received from the server 106, the user device 108, or from one or more instruction sets stored in the memory 204.

The TCU 226 may be configured and/or programmed to provide vehicle connectivity to wireless computing systems onboard and off board the vehicle 104, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 104 and other systems (e.g., a vehicle key fob (not shown in FIG. 2), the server 106, the user device 108, the infrastructure sensors 114 and/or 112, etc.), computers, and modules. The TCU 226 may be in communication with the ECUs 214 by way of a bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 106, among others.

The BCM 220 generally includes integration of sensors, vehicle performance indicators, and variable reactors associated with vehicle systems, and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some embodiments, the automotive computer 208 may connect with an infotainment system 238 (or a vehicle Human-Machine Interface (HMI)). The infotainment system 238 may include a touchscreen interface portion, and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion, and/or output or display notifications, navigation maps, etc. on the touchscreen interface portion.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In some embodiments, vehicle 104 may include an autonomous driving system 240. Vehicle 104 may be manually driven or configured to operate, using the autonomous driving system 240, in a fully autonomous (e.g., driverless) mode (e.g., Level-5 autonomy) or in one or more partial autonomous modes which may include driver assist technologies. Examples of partial autonomous (or driver assist) modes are widely understood in the art as autonomy Levels 1 through 4. For example, a vehicle having Level-1 autonomy may include a single automated driver assistance feature, such as steering or acceleration assistance. Adaptive cruise control is one such example of a Level-1 autonomous system that includes aspects of both acceleration and steering.

Level-2 autonomy in vehicles may provide driver assist technologies such as partial automation of steering and acceleration functionality, where the automated system(s) are supervised by a human driver who performs non-automated operations such as braking and other controls. In some embodiments, with Level-2 autonomous features and greater, a primary user may control the vehicle while the user is inside of the vehicle, or in some example embodiments, from a location remote from the vehicle but within a control zone extending up to several meters from the vehicle while it is in remote operation.

Level-3 autonomy in a vehicle can provide conditional automation and control of driving features. For example, Level-3 vehicle autonomy may include “environmental detection” capabilities, where the autonomous vehicle (AV) can make informed decisions independently from a present driver, such as accelerating past a slow-moving vehicle, while the present driver remains ready to retake control of the vehicle if the system is unable to execute the task.

Level-4 AVs can operate independently from a human driver, but may still include human controls for override operation. Level-4 automation may also enable a self-driving mode to intervene responsive to a predefined conditional trigger, such as a road hazard or a system event.

Level-5 AVs may include fully autonomous vehicle systems that require no human input for operation and may not include human operational driving controls.

In an embodiment, a facility/premises, e.g., facility 102 of FIG. 1, may have one or more sensors 112 and 114. These sensors are generally referred to as “infrastructure” sensors in this disclosure. These infrastructure sensors can be mounted on one more external surfaces of the facility 102. Infrastructure sensors may also include sensors not associated with the facility 102, such as sensor mounted on nearby structures, electricity poles, drones, ATM machines, towers, vehicles, or any other sensors that can be used to capture audio/video data around the facility 102. The infrastructure sensors each may have their own field of view (FOV). The field of view of each of the infrastructure sensor may cover a specific area around the facility. One or more of these infrastructure sensors may be networked together such that they all share their data with a central control server, e.g., server 106 of FIG. 1. The infrastructure sensors 112 or 114 may be operated in conjunction with each other or otherwise “linked” in some manner. For instance, if one of the infrastructure sensor 112 and/or 114 is triggered, it may result in automatic triggering of one or more of the other infrastructure sensors.

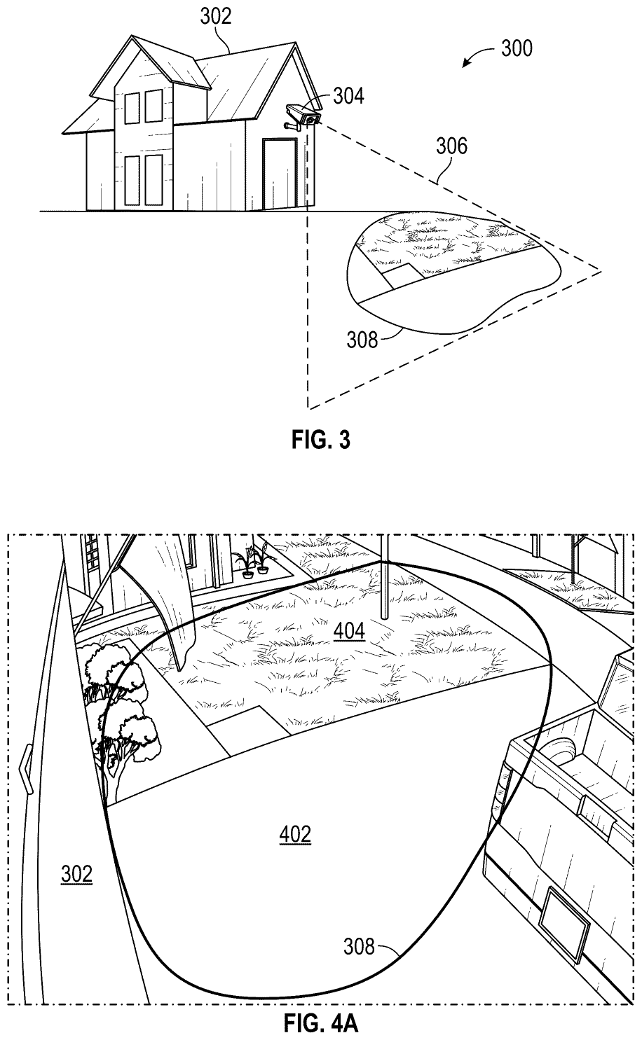

FIG. 3 illustrates an environment 300 in which the systems and methods disclosed herein can be implemented according to an embodiment of the present disclosure. FIG. 3 depicts a facility 302. In FIG. 3, a house is used to illustrate the facility 302, but it is to be understood that facility can including various other types of structures such as buildings, parking garages, multi-unit dwellings, etc. An infrastructure sensor 304 is mounted to an external surface of the facility 302. The Infrascture sensor 304, such as the sensor 112 or the sensor 114 in FIG. 1, has a field of view 306 that covers an area external to the facility 302. The Infrascture sensor 304 can monitor the area within its field of view 306 and send data regarding the area to one or more servers located in the facility 302 and/or external to the facility 302, such as server(s) 106 in FIG. 1. As noted above, sensor 304 may be any sensor that can detect presence of objects, both human and non-human, either in the night or during the daytime. In some embodiments, the user may define an area/region of interest 308 within the field of view 306. The user may be interested in specifically monitoring this region of interest 308 and not the entire area within the field of view 306. This may be for several reasons such as saving computing resources, area of interest 308 is most likely to have presence of objects, etc. The user has the ability to define this region of interest 308 using, for example, the user device 108 of FIG. 1. The several systems and methods of the present disclosure are now explained in context with such an area/region of interest.

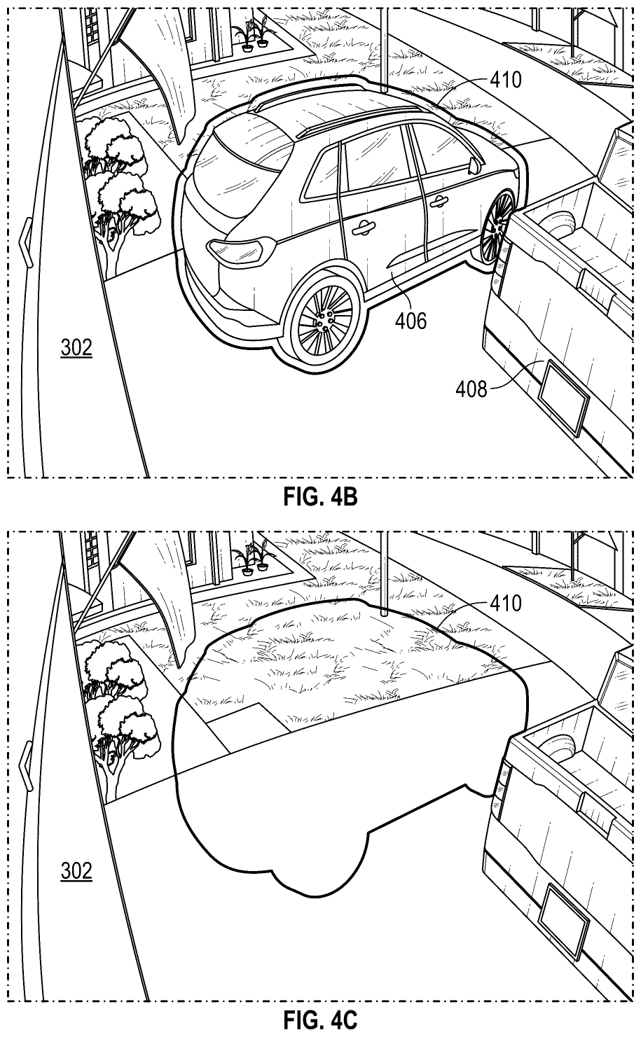

FIG. 4A illustrates a real-world example of an environment in which the systems and methods of this disclosure can be implemented according to an embodiment of the present disclosure. FIG. 4A depicts the field of view 306 of the sensor 304 (not shown) that is mounted to an external surface of a facility 302. As can be seen, the field of view includes part of a driveway 402 and a portion of a lawn/grass surface 404, among other things. As noted above, the size and content of the region of interest 308 may differ based on the location of the associated infrastructure sensor. FIG. 4B illustrates the same environment as FIG. 4A with the addition of a vehicle 406 parked in portion of the driveway. Vehicle 406 may be same as vehicle 104 of FIG. 1. Vehicle 406 is able to monitor its surroundings using one or more of its sensors. As can be seen in FIG. 4B, a region of interest (i.e., a portion of the grass surface 404) is blocked by the vehicle 406. Hence, the infrastructure sensor cannot “see” the portion of the region of interest 308 blocked by the vehicle 406. Thus, if there is any activity or object within the blocked region, the infrastructure sensor may not detect such activity or object. However, the vehicle 406 is positioned such that it can monitor and detect any activity on the grass surface 404, e.g., using one of its sensors on the door, the windshield, the roof, or the like. Thus, the vehicle 406 can augment the capabilities of the infrastructure sensor 304 while the vehicle 406 is parked in that location. As mentioned above, the vehicle 406 is capable of monitoring the environment around it including the area that is underneath the vehicle 406.

In the instance that there is some activity within the region of interest while the vehicle 406 is parked in the location, the vehicle can activate its own sensors and capture audio, visual, or any other presence detection data from within the region of interest 308 and communicate that to a control server associated with the facility 302, such as server 106 in FIG. 1. The control server can then augment the data gathered by the infrastructure sensor 304 with the data received from the vehicle 406 to generate a comprehensive visualization of the current status of the region of interest 308. This may be done by stitching two images together, overlaying the images, or any other suitable technique for combining image data. In some embodiments, portion(s) of the environment around vehicle 406 may be blocked such that even vehicle 406 may not be able to monitor such areas. For example, as shown in FIG. 4B, another vehicle 408 may also be present, close to vehicle 406, such that the vehicle 408 prevents the vehicle 406 from having a full 360 degree view of its surroundings. In such an instance, vehicle 406 may communicate with vehicle 408 using a common network, e.g., network 110 of FIG. 1, and request vehicle 408 to provide data collected by the one or more sensors of the vehicle 408. In this manner the vehicle 406 can communicate with one or more other vehicles and request and receive data collected by the sensors of those one or more other vehicles. In some embodiments, a primary vehicle, i.e., vehicle 406 in this instance, can gather the data from all other vehicles and/or the infrastructure sensors, process that data, and provide the processed data to a user device 108 associated with the vehicle 406. In other embodiments, vehicle 406 may gather raw data from all the other vehicles and send that raw data along with the data that it has collected to the control server for further processing. In yet other embodiments, the vehicle 406 and/or vehicle 408 may be caused to move or otherwise determine to move themselves autonomously to reveal the region of interest 308 to the infrastructure sensor.

There could be several reasons or events that may cause the vehicle 406 and/or the infrastructure system to request the gathering of visual, presence, or audio data. In one example, the infrastructure sensor 304 may detect some activity within the region of interest but the associated control server or system may not be able to ascertain the nature of the activity, or any object associated with that activity, e.g., due to the vehicle 406 blocking part or the whole of the region of interest. In this instance, the control server, which is associated with the infrastructure sensor 304, may send a message to the vehicle 406 and request data (e.g., audio/visual data) for the region of interest. Once the vehicle 406 gets this message, it may activate one or more of its sensors and start gathering data for the region of interest. The vehicle 406 may then send that data to the control server (e.g., server 106 of FIG. 1). The control server may then combine the data received from the vehicle 406 and the data received from the infrastructure sensor 304 to generate combined data that provides comprehensive information regarding the region of interest 308. In one embodiment, the control server may overlay the data received from the vehicle 406 over the data received from the infrastructure sensor 304 to generate a combined image that shows the current status of the region of interest 308. In other embodiments, the vehicle 406 may receive the data from the infrastructure sensor 304 and combine that data with the data that the vehicle 406 has gathered, process the data, and then send the combined data to the user device 108 associated with the vehicle and/or to the control server associated with the facility 302.

In an embodiment, the data from the vehicle 406 and the data from the one or more infrastructure sensors 304 may be combined in a manner to make the vehicle “invisible”, as illustrated in FIG. 4C. As illustrated in FIG. 4B, the vehicle 406 is blocking the region of interest 308. Due to this, the infrastructure sensor is not able to view the blocked region of interest 308. In this instance, the vehicle 406 can be made invisible and replaced by an outline 410 representing the location of the vehicle 406, as illustrated in FIG. 4C. In this embodiment, the control server determines, based on the data from the infrastructure sensor that the vehicle 406 is blocking the region of interest (i.e., a portion of the grass surface 404 and portion of the driveway 402). The control server may then send a message to the vehicle 406 to gather data associated with the blocked portions of the grass surface 404 and portion of the driveway 402. This causes the vehicle to activate one or more of its sensors and gather data associated with the blocked portions of the grass surface 404 and a portion of the driveway 402. The vehicle may then send this data back to the control server. The control server may then use one or more of known image processing techniques to combine the data from the infrastructure sensors and the vehicle. In doing so, the control server may (i) determine the extent of the vehicle 406 and create a mask/outline 410 that represents the external/outer contour/periphery of the vehicle 406 and (ii) replace the portion of the vehicle 406 as detected by the infrastructure sensor(s) with the data received from the vehicle 406. The resulting combined image is depicted in FIG. 4C. As shown in FIG. 4C, the vehicle 406 is “hidden” and the vehicle 406 is replaced by an image of the portion of the lawn surface 404 and the driveway 402 that was blocked by the vehicle 406. The vehicle 406 is represented by its periphery mask 410 that indicates the approximate location of the vehicle 406. This image can then be presented on a user device associated with the vehicle or via a display associated with the control server. It is to be noted that the vehicle 406 is still physically present in the location shown, it is made “invisible” just for display purposes. Data from the vehicle 406 may be gathered continually or in periodic intervals and the combined data is updated to display the most recent status of the region of interest. The displayed combined data can either be an image or a video. The advantage of this embodiment is that even if a vehicle is blocking a particular view, the user can still monitor the blocked region using a combination of the vehicle and the infrastructure sensors. Further, a time stamp may be superimposed on the combined image to show the time of the last image update.

In some instances, the vehicle 406 may be in a location such that a particular part of the blocked region of interest may be not clearly “visible” to the vehicle. In this instance, even if the vehicle collects the data about the region of interest, that data may be not useful in monitoring the region of interest. In such situations, the control server can send a message to the vehicle that causes the vehicle to autonomously move forwards, backwards, or sideways (as long it is appropriate to do so) in order to position itself to get a better coverage of the region of interest. In other embodiments, the vehicle may make the determination that it is unable to monitor certain part of the region of interest. The vehicle may then determine the relative location of the part of the region of interest with respect to the vehicle, determine a target location to be at to be able to monitor/view the part of the region of interest, determine a distance and direction that the vehicle needs to move in order to be at the target location, determine that it is appropriate to move the distance and in the direction, and place itself in the target location. Once the vehicle is at the target location, it can start collecting data associated with the region of interest. This ensures that the collected data is useful in monitoring the region of interest.

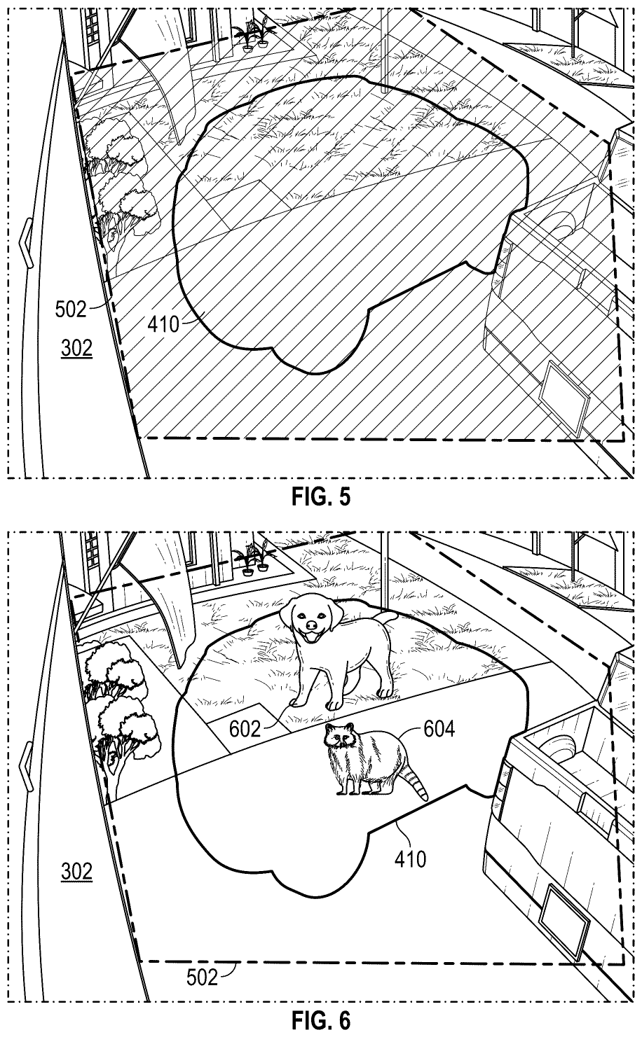

In some embodiments, the system and methods described above may be used in specific instances. For example, we may not want to make all the vehicles “invisible” in the manner described above. Instead, we may want to only make a vehicle invisible if it is present in a certain location, we may want to make the vehicle invisible for a specific purpose, etc. In one embodiment, the systems and methods described in this disclosure are applied only if the vehicle is present within a specific area. FIG. 5 depicts an area 502 associated with the facility 302. In an embodiment, a user can designate the area 502 via a user device, e.g., user device 108, of FIG. 1. Information about the area 502 may be stored in the control server, in the vehicle memory, and/or in the user device 108 and an application associated with the vehicle 406. In operation, if the vehicle 406 is determined to be in any portion of the area 502, the process of gathering data may be triggered. For instance, once the vehicle 406 is within any portion of the area 502, the control server may send a message to the vehicle 406 and the vehicle 406 may immediately or after some delay, start gathering data via its various sensors such as forward/front facing camera, under-body camera, proximity sensors, RADAR, LiDAR, rear-facing camera, etc. In some instances, the vehicle 406 may still be in motion when it starts collecting the data. In other instances, the vehicle 406 starts collecting data once it is fully stopped. In the instance where the vehicle 406 starts collecting data while still in motion (e.g., a vehicle pulling into the driveway), it may collect data about areas on the ground that are not currently underneath the vehicle when it is in motion but will be once the vehicle is fully stopped. Such information may be useful in monitoring for objects that may be underneath the vehicle at a future time.

Once the vehicle 406 starts collecting the data about its surroundings, it can send that data to the control server. By restricting collection of data only if the vehicle 406 is within a designated area helps to reduce the computational load of the vehicle as well as the control server and may circumvent monitoring of areas that may trigger a privacy concern. In this manner, an owner/user of the facility can tailor the monitoring to include only the area that he/she deems to be relevant and prevents expansive monitoring that may not be needed.

In another instance, the owner/user of the facility may want to ensure that the monitoring is effective and not all vehicles detected by the infrastructure cameras are made invisible. In this situation, the system can be programmed to make certain specific vehicles “invisible.” For instance, continuing our example of a home monitoring situation, consider that the owner of the house has two vehicles. So, the owner may be less concerned about his security system always showing his/her two vehicles on the driveway. However, the owner may want to ensure that any other vehicle, such as a delivery van, truck, ambulance, police car, etc. is visible even if that vehicle is blocking any portion of the region of interest. In this instance, the homeowner may designate his/her two vehicles as “authorized” vehicles. In this embodiment, “authorized” simply means that the homeowner would like these vehicles to be presented as an associated periphery mask (i.e., outline 410 of FIG. 4C) on his/her user device and/or his security system console whenever any of the two authorized vehicles is within the region of interest. In an embodiment, the homeowner may provide the control server with one or more identification information or data for each of the two vehicles. Identification information may include license plate number, make and model, color, and/or any other distinguishing characteristics of each of the two vehicles.

In operation, when the system detects a vehicle entering the region of interest or if a vehicle is already present in the region of interest, one or more infrastructure cameras may gather data about the vehicle (e.g., license plate image, vehicle image, etc.) and send that data to the control server. The control server may then determine whether the detected vehicle is an authorized vehicle or not by comparing the data received from the one or more infrastructure cameras with the pre-stored identification information of vehicles designated as “authorized.” If the control server determines that the vehicle currently present within the region of interest is not an authorized vehicle, the control sever may not initiate the process described above for making the vehicle invisible and instead cause the vehicle to be displayed via the user device or the control server console. If the control server determines that the vehicle currently present within the region of interest is “authorized”, the control sever may initiate the process described above and cause the periphery mask associated with the vehicle to be displayed and the vehicle to be hidden from image displayed on the user device and/or the control sever console.

There may be situations where it may be beneficial to determine an object that may be underneath the vehicle 406. Often objects like pets or other animals may inadvertently wander underneath the vehicle 406. In most instances, such animals remain under the vehicle 406 for a short period of time. However, in some instances pets and other animals may reside underneath the vehicle 406 for extended periods of time. Other than pets or other animals, other objects like toys, furniture articles, and the like may find their way under the vehicle 406. In any of the above situations, it would be helpful to know whether there is any object under the vehicle 406 before the vehicle 406 is operated. Currently, the most common way to figure this out is for the user of the vehicle to physically look under the vehicle to confirm that there is no object under the vehicle. However, often users of vehicles may neglect to check this, which can result in an unwanted situation occurring. Systems and methods described below are useful in solving this issue by giving the user advance notification if an object is present underneath the vehicle.

In some embodiments of the present disclosure, vehicles can be equipped with an under-body sensor, like a camera, which can monitor the area under the vehicle. The under-body sensor may continuously monitor the area under the vehicle, or monitor the area under the vehicle on-demand, or monitor the area under the vehicle periodically. In some embodiments, a combination of sensors may be used for the monitoring instead of a single sensor. For instance, a low-resolution sensor, such as a Passive Infrared Detection (PID) sensor, may first detect movement under the vehicle. Based on the detected movement, a higher resolution sensor, such as a RGB (Red, Green, Blue) camera, may be activated to capture an image or video of the object. By using such a two-sensor arrangement, significant power savings can be achieved for the vehicle since the higher power consuming high resolution sensor is only activated if some type of movement is detected by the low-resolution sensor.

FIG. 6 illustrates a scenario in which the vehicle monitors the area under the vehicle as well as the region of interest 502 according to an embodiment of the present disclosure. In this embodiment, the control server/system associated with the infrastructure sensors may determine that the region of interest 502 is not fully visible. The control server/system associated with the infrastructure sensor(s) may further determine that a vehicle is present and blocking at least a portion of the region of interest 502. The control server may then send a message to the vehicle (e.g., vehicle 406) requesting the vehicle to send data associated with the portion of the region of interest. The vehicle upon receiving the message may activate one or more of its sensors to start monitoring the region of interest. The vehicle captures data associated with the region of interest 502 using one or more of its sensors. The vehicle may also receive the data captured by the infrastructure senor(s), for example, from the control server. The vehicle processes both the data that it captures and the data captured by the infrastructure senor(s) and generates combined data. In some embodiments, the infrastructure sensor(s) may capture an image of the region of interest 502 that depicts a portion of the region of interest and a portion of the vehicle (e.g., vehicle 406) that is blocking at least another portion of the region of interest 502. The vehicle 406 may capture a second image that includes an image of the other portion of the region of interest that the infrastructure sensor(s) cannot see and other additional items that can only be detected by the vehicle or by both the vehicle and the infrastructure sensor(s). In this instance, the combined data includes the first image captured by the infrastructure sensor(s) that is overlaid by the second image captured by the vehicle. This combined image may be displayed on the appropriate device (e.g., the user device 108, or the display associated with the control sever, or the HMI interface of the vehicle 406). In the combined image, the portion of the vehicle in the first image may be replaced by an image of the portion of the region of interest that is blocked by the portion of the vehicle. Further, a periphery mask 410 for the vehicle may be determined and the periphery mask may be displayed in the combined image to illustrate the location of the vehicle 406. The combined image may look like the image shown in FIG. 4C.

In addition, the combined image may also display approximate location of one or more objects detected by the vehicle. For example, as shown in FIG. 6, the vehicle may detect presence of a first object 602 (e.g., a dog) that may be present within the region of interest 502. The vehicle may also detect another object 604 (e.g., a raccoon) that may be present underneath the vehicle. Both these objects 602 and 604 are then depicted in the final image displayed on the appropriate device. In this manner, the user is made aware of presence of object(s) around and under the vehicle thereby enhancing the security within the region of interest. In some instances, once the vehicle detects presence of objects around and/or under the vehicle, the vehicle may perform image/data analysis to determine the identity of the object. This analysis may be done in any number of ways such as using image recognition, pattern matching, using machine learning models, and the like. Once the identity of the object(s) is determined, that information may be used to depict the object in the final image. In some instances, if the objects are associated with the facility, such as, family members of a household, pets, etc. then the actual image of the person or pet may be displayed after the object identification is completed. In other instances, if an unknown object, such as, a neighbor's dog, is detected in the region of interest 502, the vehicle may identify the object as a dog and display a generic image of a dog to represent the neighbor's dog. Similarly, if unknown objects or wild animals are detected, the vehicle my use generic or symbolic representations to depict such objects or animals in the combined image. In some instances, the vehicle may send the raw sensor data captured by the vehicle's sensors to the control server and the control server may then interpret the data and send the final data, e.g., the combined/final image from above, to the appropriate device.

In many instances, presence of objects within the region of interest 502 may be temporary. For example, a cat may just pass underneath the vehicle but not stay there. In order to prevent unnecessary data gathering and processing, the vehicle may use a timer to determine whether to capture and/or process the data related to the object. For example, an animal may approach the vehicle 406 from a first side. Once the vehicle 406 detects the presence of the animal, it can activate the appropriate sensor(s) to track the animal. As the animal goes under the vehicle 406, an under-body sensor of the vehicle 406 may detect the animal. Thereafter the animal may emerge from under the vehicle 406 and walk away from the vehicle 406. Let's assume that all of this happens in a span of 45 secs. In this instance, the vehicle may employ a timer set to one minute before it starts processing the captured data. The data captured as the animal approaches the vehicle 406 until it moves away from the vehicle 406 may be stored in a circular buffer (e.g., a First-In-First-Out (FIFO) buffer) where new data overwrites the old data. In this instance, the vehicle may start the timer as soon as it detects the animal. The vehicle may start capturing data related to the animal concurrently to starting the timer, but it may not process the data or send that data to the control server until the timer has expired. If the vehicle detects that the animal has moved away from the vehicle before expiry of the timer, the vehicle my purge the data from the circular buffer without any further processing of the data. This prevents processing of data for transient events like an animal passing by, which is likely to be of less interest to the user. In the instance where the vehicle does not detect the animal moving away from the vehicle and the timer expires, the vehicle may then send some or all the captured data in the circular buffer to the control server for further processing or process that data itself to determine the identity and/or approximate location of the animal. In an embodiment, the timer value represents a permanence associated with the object and the threshold valve (e.g., 1 minute in the above example) represents a permanence threshold value. Thus, in this instance, the vehicle may process the captured data if the permanence value associated with the object is equal to or exceeds the permanence threshold value.

In some embodiments, if there is an object under or near the vehicle and the vehicle detects presence of a user in the vicinity of the vehicle or detects the user attempting to operate the vehicle, e.g., opening the vehicle door, or operating a gear changer, etc., the vehicle may output an audio and/or a visual notification alerting the user of the presence of the object. For example, pre-recorded alert messages may be output via the loud speakers of the vehicle or an alert message may be displayed via the human-machine interface (HMI) of the vehicle. In some embodiments, certain functions of the vehicle may be temporarily disabled until the object is present and/or the user acknowledges the alert message and takes a follow-up or a follow-on action. For example, the ability to shift the vehicle from “park” to “drive” may be disabled until the user of the vehicle acknowledges the audio and or the visual alert message.

In some embodiments, it may be beneficial to prevent an object, e.g., an animal, from approaching the vehicle or getting under the vehicle. In this instance, when the vehicle detects an animal approaching the vehicle, it may play one or more pre-recorded messages, sounds, etc. or operate the external lights of the vehicle to scare the animal or generally discourage the animal from approaching the vehicle. In other instances where an animal is detected under the vehicle, pre-recorded messages can be played to encourage the animal to get out from under the vehicle. For example, if the family pet is detected under the vehicle, a pre-recorded message in the owner(s) voice may be played to instruct the pet to come out from under the vehicle. In other instances, the user may be able to use the user device to connect to the vehicle and give instructions for the pet to move from under the vehicle via the user device and using the vehicle loudspeakers.

In some embodiments, machine learning techniques may be employed to further enhance the usefulness of the captured data. For example, a machine learning model can be trained to analyze the captured data, identify the detected objects and classify the objects based on one or more rules or criteria. For example, if the detect object(s) is a person, then the model may determine whether the person has opted-in or opted-out of being identified. If the person has opted-out from being identified, the system may obfuscate the identity of the person, e.g., by representing the person as a stick figure, or some other representation that hides the identity of the person. In some embodiments, images or video captured from before the person is detected may be used to patch over the presence of the person to make the person invisible to anyone watching the camera feed. This can be especially helpful in a law enforcement scenario where a police car, police personnel, etc. who may be responding to a situation can be made “invisible” to the person(s) committing the crime and/or persons who may have access to the security system at the location where the crime is being committed. Similarly, as described above, the machine learning model can be programmed to recognize “authorized” vehicles and automatically make them invisible to anyone looking at the associated camera feed.

In addition, various other applications are possible based on the data captured by the vehicle and/or the infrastructure cameras. For example, the machine learning model can be programmed to recognize contextual awareness and output a result accordingly. This will further enhance the usefulness of the captured data. For example, the system may be programmed to determine the difference between (a) detecting a family pet that is outside the house, but with a leash on, and a family member in close proximity to the family pet and (b) detecting the family pet outside the house and without a leash. In most instances, situation (a) would not warrant an alert message, but situation (b) would warrant a message sent to the user device or the vehicle outputting an alert message. Further in case of situation (a) the system can automatically hide the image of the family pet and the family member using any of the systems and methods described above. However, in case of situation (b), the image of the family pet would not be hidden so that the user may see the presence of the family pet outside the house and take appropriate action. In some embodiments, the user can designate which objects or class of objects are to be hidden and which ones are not to be hidden.

In some embodiments, the vehicle can work in conjunction with other sensors such as, wireless air tags, mobile phones, and the like to monitor people, animals, and objects in the region of interest. These wireless sensors may send data to the vehicle and the vehicle may either process the data itself or send that data to the server for processing. In some instances, the vehicle can send an alert notification if it determines that an animal or a person is within or near to the prescribed boundary of the region of interest. This alert notification can be in the form of an audio or visual message. In some embodiments, where the alert notification is in a visual form, the intensity and/or frequency of the alert notification may increase (e.g., increased blinking of a visual indicator, increasing frequency of text message notification, etc.) as the person/animal near the boundary or is within the boundary of the region of interest. In the instance when the alert notification is in an audio form, the pitch, frequency, or volume of the audio alert may increase as the person/animal approaches the boundary or is within the boundary of the region of interest.

FIG. 7 illustrates a flow chart for a process 700 according to an embodiment of the present disclosure. Process 700 may be performed, for example, by the vehicle 104 of FIG. 1. At step 702, the vehicle may receive a request (e.g., from a control server or a user device associated with the vehicle) to capture an image of a region of interest. In this instance, the region of interest is blocked from view of a first sensor associated with the control server. After receiving the request, the vehicle may activate its appropriate sensor(s) and capture a first image of the region of interest using the appropriate sensor(s) of the vehicle at step 704. The determination of the appropriate sensor may be based on, for instance, the known or determined orientation of the vehicle, and the relative position of the region of interest thereto, by trial and error (e.g., image analysis of images from each of the different sensors of the vehicle), or it may be a predetermined sensor. It may also be a combination of two or more images take by a sensor of the vehicle, for example, that have been knit together to adequately cover the region of interest. Thereafter, at step 706, the vehicle may receive a second image captured by the first sensor and the second image may include a portion of the vehicle. At step 708, the vehicle may generate a combined image using the first and the second images. In the combined image, the portion of the vehicle is replaced with a portion of the region of interest. Then, at step 710, the vehicle may send the combined image to a user device or to the control server. The combined image is then displayed by the user device or the control server.

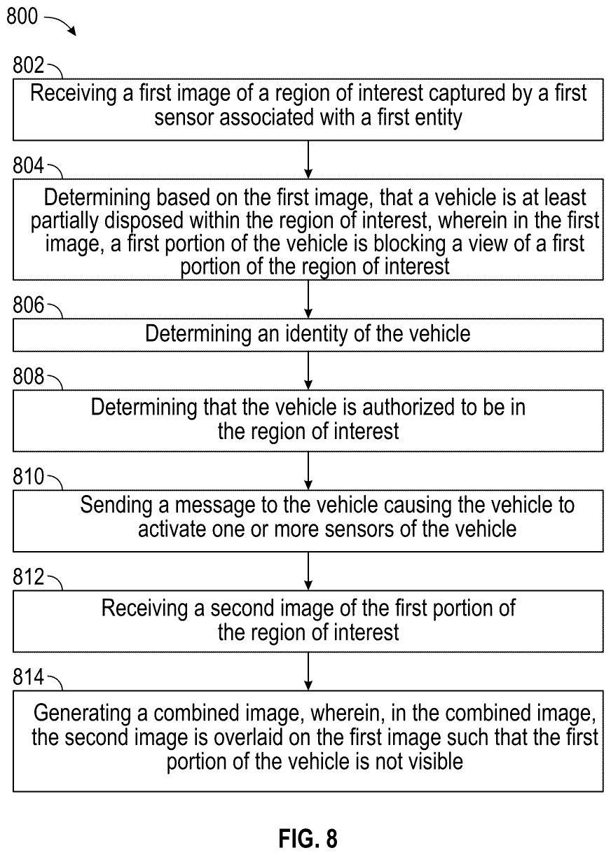

FIG. 8 illustrates a flow chart for a process 800 according to an embodiment of the present disclosure. Process 800 may be performed, for example, by the user device 108 of FIG. 1. At step 802, the user device may receive a first image of a region of interest captured by a first sensor associated with a first entity. The first entity may be a security system or other infrastructure sensors that are separate from the user device and a vehicle associated with the user device. At step 804, the user device determines, based on the first image, that a vehicle is at least partially disposed within the region of interest. The first image may also depict that a first portion of the vehicle is blocking a view of a first portion of the region of interest. At step 806, the user device determines an identity of the vehicle (e.g., using license plate information or other characteristics of the vehicle). Once the identity of the vehicle is determined, the user device can then determine whether the vehicle is authorized to be in the region of interest. At step 808, the user device may determine that the vehicle is authorized to be in the region of interest. Then, at step 810, the user device may send a message to the vehicle causing the vehicle to activate one or more sensors of the vehicle. The user device receives a second image from the vehicle at step 812. The second image depicts the first portion of the region of interest. Thereafter, at step 814, the user device generates a combined image. In the combined image, the second image is overlaid on the first image such that the first portion of the vehicle is not visible.

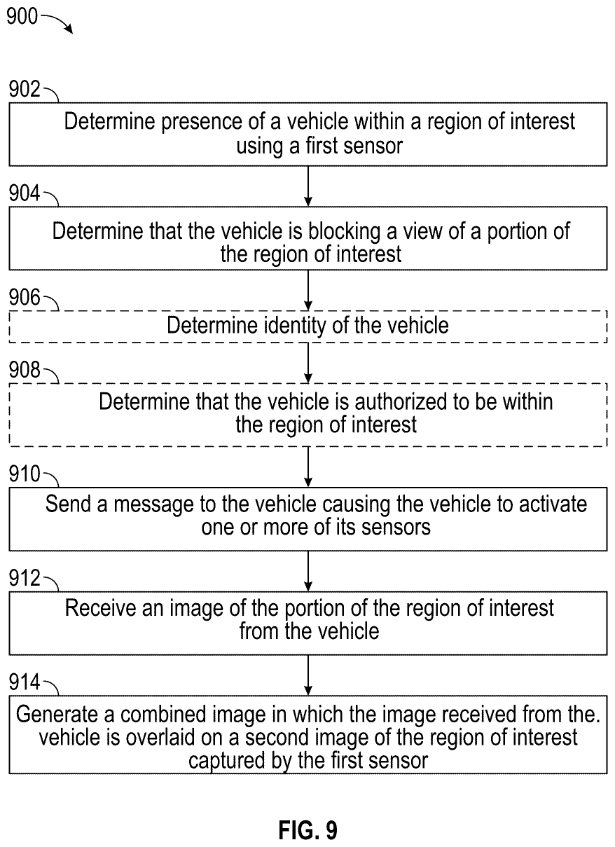

FIG. 9 illustrates a flow chart for a process 900 according to an embodiment of the present disclosure. Process 900 may be performed, for example, by the server 106 of FIG. 1. At step 901, the server determines presence of a vehicle within a region of interest using a first sensor associated with the server. Then at step 904, the server determines that the vehicle is blocking a view of a portion of the region of interest. Thereafter, the server determines an identity of the vehicle at step 906. It is to be noted that step 906 is an optional step and can be omitted if desired. At step 908, the server may determine whether the vehicle is authorized to be within the region of interest. It is to be noted that step 908 is an optional step and can be omitted if desired. If it is determined that the vehicle is not authorized to be within the region of interest, process 900 terminates and the first sensor continues to monitor the region of interest. the If it is determined that the vehicle is authorized to be within the region of interest, the server sends a message to the vehicle causing the vehicle to activate one or more of its sensors at step 910. If steps 906 and 908 are omitted, then the server may send the message to the vehicle after step 904. Then, at step 912, the server receives an image of the portion of the region of interest from the vehicle. Upon receiving the image from the vehicle, the server generates a combined image in which the image received from the vehicle is overlaid on a second image of the region of interest captured by the first sensor, at step 914.

It is to be noted that the vehicle implements and/or performs operations, as described here in the present disclosure, in accordance with the owner manual and safety guidelines. In addition, any action taken by the vehicle owner based on recommendations or notifications provided by the vehicle should comply with all the rules specific to the location and operation of the vehicle (e.g., Federal, state, country, city, etc.). The recommendation or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method comprising:
receiving, by a vehicle from a control server, a request to capture an image of a region of interest, wherein at least a portion of the region of interest is blocked from view of a first sensor associated with the control server;
capturing, by the vehicle, a first image of the region of interest using a second sensor of the vehicle;
receiving, by the vehicle from the control server, a second image, the second image captured by the first sensor and including a portion of the vehicle; and
generating, by the vehicle, a combined image using the first and the second images, wherein in the combined image, the portion of the vehicle is replaced with a portion of the region of interest.

2. The method of claim 1, further comprising, sending, by the vehicle, the combined image to a user device associated with the vehicle.

3. The method of claim 1, wherein capturing the first image further comprising:
autonomously moving the vehicle from its current location to a target location; and
capturing the first image from the target location.

4. The method of claim 1, further comprising, prior to generating the combined image:
detecting, by the vehicle using the second sensor or a third sensor, presence of an object within the region of interest;
determining, by the vehicle, a permanence associated with the object; and
determining, by the vehicle, that the permanence is above a threshold.

5. The method of claim 1, wherein the control sever is associated with a security system that is separate from the vehicle.

6. The method of claim 1, further comprising, prior to generating the combined image:
detecting, by the vehicle, presence of an object within the portion of the region of interest; and
determining, by the vehicle that a permanence associated with the object is above a threshold.

7. The method of claim 1, wherein the region of interest is definable using a user device associated with the vehicle.

8. The method of claim 1, wherein generating the combined image further comprising:
receiving, a third image of the region of interest from a second vehicle; and
generating the combined image further using the third image.

9. A method comprising:
receiving, by a user device, a first image of a region of interest captured by a first sensor associated with a first entity;
determining, by the user device and based on the first image, that a vehicle is at least partially disposed within the region of interest, wherein in the first image, a first portion of the vehicle is blocking a view of a first portion of the region of interest;
determining, by the user device, an identity of the vehicle;
sending, by the user device, a message to the vehicle causing the vehicle to activate one or more sensors of the vehicle;
receiving, by the user device from the vehicle, a second image of the first portion of the region of interest; and
generating, by the user device, a combined image, wherein, in the combined image, the second image is overlaid on the first image such that the first portion of the vehicle is not visible.

10. The method of claim 9, wherein the message includes information about which of the one or more sensors are to be activated.

11. The method of claim 9, further comprising, prior to generating the combined image, determining that the vehicle is authorized to be present within the region of interest.

12. The method of claim 9, further comprising:
detecting, using the second image, presence of an object within the first portion of the region of interest;
determining a permanence associated with the object; and
determining that the permanence is above a threshold.

13. The method of claim 9, wherein the first portion of the region of interest is an area underneath the vehicle.

14. The method of claim 9, further comprising:
generating a periphery mask associated with the vehicle, the periphery mask showing an outline of the vehicle; and
including the periphery mask in the combined image.

15. The method of claim 9, further comprising:
detecting presence of an object within the first portion of the region of interest;
determining whether the object is of a first type or a second type;
causing the vehicle to perform a first action if the object is of the first type; and
causing the vehicle to perform a second action if the object is of the second type.

16. A vehicle comprising:
one or more processors;
a memory coupled to the one or more processors;
a communication interface coupled to the one or more processors;
one or more sensors coupled to the one or more processors;
wherein the vehicle is configured to:
receive, via the communication interface from a remote server, a first image of a region of interest, wherein in the first image, a first portion of the vehicle is obscuring a first portion of the region of interest;
receive, from the remote server, a request to capture an image of the region of interest;
capture, using the one or more sensors, a second image of the first portion of the region of interest; and
generate, using the first image and the second image, a combined image, wherein in the combined image, the first portion of the vehicle in the first image is replaced with the first portion of the region of interest from the second image.

17. The vehicle of claim 16, wherein the one or more sensors include: a proximity sensor, a motion detection sensor, a RADAR, a LiDAR, a camera, or a vibration sensor.

18. The vehicle of claim 16, wherein the vehicle is further configured to:
Detect the presence of an object within the first portion of the region of interest;
determine whether the object is of a first type or a second type;
perform a first action if the object is of the first type; or perform a second action if the object is of the second type.

19. The vehicle of claim 16, wherein the vehicle is further configured to:
generate a periphery mask, wherein the periphery mask defines an outer contour of the vehicle; and
include the periphery mask in the combined image.

20. The vehicle of claim 16, wherein the vehicle is further configured to, prior to capturing the second image:
determine a target location;
autonomously move from its current location to the target location; and
capture the second image from the target location.

21. The vehicle of claim 16, wherein prior to generating the combined image, the vehicle is further configured to:
Detect the presence of an object within the first portion of the region of interest;
determine a permanence associated with the object; and
determine that the permanence is above a threshold.
